(19) United States
(12) Patent Application Publication
(10) Pub. No.: US 2014/0044333 A1
(43) Pub. Date: Feb. 13, 2014

(54) SYSTEM AND METHOD FOR PROVIDING REGISTRATION BETWEEN BREAST SHAPES BEFORE AND DURING SURGERY

(71) Applicants: Richard J. Barth, JR., Hanover, NH (US); Songbai Ji, Lebanon, NH (US); Keith D. Paulsen, Hanover, NH (US); Matthew J. Pallone, Hartford, VT (US)

(72) Inventors: Richard J. Barth, JR., Hanover, NH (US); Songbai Ji, Lebanon, NH (US); Keith D. Paulsen, Hanover, NH (US); Matthew J. Pallone, Hartford, VT (US)

(73) Assignee: Dartmouth College, Hanover, NH (US)

(21) Appl. No.: 14/000,068

(22) PCT Filed: Feb. 17, 2012
(86) PCT No.: PCT/US12/25671

§ 371 Date: Oct. 22, 2013

Related U.S. Application Data
(60) Provisional application No. 61/443,793, filed on Feb. 17, 2011.

(51) Int. Cl. G06T 7/00

(52) U.S. Cl. CPC G06T 7/0012
USPC 382/131

(57) ABSTRACT

A registration framework is presented that registers volumetric breast images captured before surgery with intraoperative surface images. The framework may be implemented using either image-based or model-based registration techniques. The method contains the steps of: identifying an air/tissue boundary from a volumetric image created at a first time; processing the volumetric image with an image filter to emphasize the air/tissue boundary; and registering a surface optically scanned image, with the filtered volumetric image, where the surface optically scanned image is created at a second time.

### FIELD OF THE INVENTION

The present invention relates to medical imaging, and more particularly, is related to registration of preoperative volumetric images to intraoperative surface image data.

### BACKGROUND

Many women with breast cancer have their tumors detected by screening mammography or breast magnetic resonance imaging (MRI), before the tumors become clinically palpable. Most of these women with small breast cancers will typically choose breast conserving surgery. The goal of breast conserving surgery is to completely resect the tumor with negative margins and simultaneously preserve the shape of the breast. The standard technique for breast conserving surgery for patients with non-palpable breast cancer is to place a wire into the cancer preoperatively (in radiology under, for example, mammographic, ultrasound or MRI guidance) and then, in the operating room (OR), to excise the tissue around the wire. This technique, initially developed in the 1970's, has several limitations. For example, the wire localization method adds a separate procedure to the surgical resection, thereby complicating and lengthening the process. Standard localization involves placement of one wire as close as possible to the clip left at the time of diagnostic core biopsy, or close to residual masses or calcifications. Mammographic images are typically then taken in two projections and the surgeon may then estimate the location of the cancer from these wire localization films. In many cases this may imprecisely localize the cancer, resulting in positive margin rates, for example, from 30-50%. Additional precision can be gained by placing additional wires, but this may increase the length of time for the localization procedure. Therefore, wire localization can be an inefficient and imprecise technique.

Due to these limitations, it is desirable to find alternatives to wire localization. Intraoperative ultrasound has been evaluated and been shown to be superior to wire localization, but many of mammographically visible invasive cancers and most ductal carcinoma in situ lesions may not be visible on ultrasound. Targeting the resection at the hematoma left from the initial core biopsy has had some success in early retrospective studies. Neither of these techniques has been widely adopted.

MRI of the breast has been shown by multiple studies to be more sensitive than mammography for the detection of breast cancer. Furthermore, several studies have demonstrated the ability of MRI to detect mammographically and clinically occult foci of cancer in the ipsilateral breast in approximately 25% of patients. In some cases the local extent of the tumor may be better defined by MRI, while in some cases additional foci of cancer are seen in other quadrants of the breast.

Preoperative images refer to medical images acquired preoperatively or surgical plans based on preoperative images. Examples of technologies used to capture preoperative images include magnetic resonance (MR) and computed tomography (CT). Volumetric preoperative images may be thought of as a series of tomographic two dimensional slices of a subject arranged so the images collectively represent the subject in three dimensions. Intraoperative images, on the other hand, are images captured during a surgical operation. Optical imaging is frequently used for diagnostic and intraoperative imaging purposes. Optical imaging refers to a class of imaging methodologies including, but not limited to, laser scanning and stereovision. The need for intraoperative registration arises because there may be an unknown spatial relationship between preoperative volumetric and intraoperative surface data in the operating room. While it may be possible to visualize a portion of the anatomy of a patient within the preoperative medical images, and also to visualize the same anatomy using intraoperative data such as optical imaging, the precise spatial correspondence between the representations may be unknown. For example, the soft tissue of an internal organ may be displaced or deformed during surgery, making it difficult to correlate the location of a feature in an intraoperative optical image to the location of the feature in a preoperative magnetic resonance image.

Furthermore, since breast tissue is soft and malleable, it readily deforms in response to forces such as gravity. Some surgeons prefer diagnostic volumetric breast imaging while the subject is in the prone (face down) position, as gravity draws the breast tissue from the chest surface, making it easier to visually isolate breast tissue from chest tissue. However, most breast surgery is performed while the subject is in a supine (face up) position. When the subject is in the supine position, the shape of the breast may be considerably different from when the subject is in the prone position, as the breast is subject to a 1 G force away from the chest wall when the subject is in the prone position, while the breast is subject to a 1 G force toward the chest wall when the subject is in the supine position. For example, the breast may exhibit more vertical compression, and more lateral displacement and expansion when the subject is in the supine position. Since the chest surface of the supine subject may not be perfectly horizontal, the tissue may tend to be drawn by gravitational forces in a direction corresponding to the downward slope of the chest surface. Therefore, the location of an internal point of interest from a preoperative volumetric image may be difficult to discern due to the distortion of the internal tissue relative to the breast surface. That is, the relation of surface features, such as the nipple, to internal tissue, such as a cancerous growth, may not be consistent between the preoperative prone volumetric image and the intraoperative optical scan image.

Furthermore, the amount and type of relative displacement may not be consistent among patients. FIG. 1 shows diagrams of a breast of a first subject 110, a breast of a second subject 120 and a breast of a third subject 130 from a perspective above the head of each subject. The three subjects of FIG. 1 are depicted in the prone position. A chest wall outline 116, 126 and 136 is shown for the three subjects, and an imaginary center axis 118, 128 and 138 is shown, indicating a mid point of the breasts 110, 120 and 130 relative to the chest walls 116, 126 and 136. Each diagram depicts the relationship of a nipple 112, 122 and 132 in relationship to an internal region of interest 115, 125 and 135. The region of interest 115, 125 and 135 may be, for example, a cluster of cancerous cells. FIG. 1 represents the position a subject during a prone volumetric image.

In contrast, FIG. 2 represents the position a subject may be in during a supine surface image. The perspective of FIG. 2 is from above a subject in the supine position. FIG. 2 shows sketches of the breast of a first subject 110, the breast of a second subject 120 and the breast of a third subject 130, when the subjects are in the supine position. The breast of the first subject 110 demonstrates both vertical compression and horizontal displacement, with both the nipple 112 and the region of interest 115 having been distorted in relation to the center axis 118 in comparison to FIG. 1. The breast of the second subject 120 also demonstrates both vertical compression and horizontal displacement, with both the nipple 112 and the region of interest 115 having been distorted in relation to the center axis 118 in comparison to FIG. 1. However, the relational positions of the elements of the second subject 120 are different from the first subject 110. Such variations may be due to, for example, the amount of breast tissue, the relative density of the breast tissue, and the amount of surface area. In contrast, while the breast of the third subject 130 demonstrates some vertical compression, it demonstrates significantly less horizontal displacement. Such variations illustrate the potential difficulties of locating an internal region of interest in relation to external features when images are taken with the subject in a different position from the position of the subject in the operating room.

The understanding and interpretation of intraoperative optical images may be greatly facilitated by registering them with images generated with other modalities, most notably, MR and CT images. Image registration is the process of transforming different sets of data into one common coordinate system. Data may be multiple photographs, data from different sensors, from different times, or from different viewpoints. Image registration is used in computer vision, medical imaging, military automatic target recognition, and compiling and analyzing images and data from satellites. Registration is necessary in order to compare or integrate the data obtained from these different measurements.

In imaging technology, a fiduciary marker, or fiducial, is an object used in the field of view of an imaging system which appears in the image produced, for use as a point of reference or a measure. It may be either something placed into or on the imaging subject, or a mark or set of marks in the reticle of an optical instrument. Fiduciary markers are used in a wide range of medical imaging applications. Images of the same subject produced with two different imaging systems may be correlated by placing a set of fiduciary markers in the area imaged by both systems. In this case, a set of markers which are visible in the images produced by both imaging modalities must be used. In general, a minimum of 3 non-colinear markers must be used for rigid registration. In practice, more markers are generally used. However, even when a large number of fiducials are used, difficulty may arise when registering a first image with a second image where there has been significant tissue displacement between the first and second image.

Affine registration means that the registration transformation is an affine transformation, which includes translation, rotation, as well as scaling and shearing. By contrast, a rigid registration only involves translation and rotation. It may be convenient to think of rigid registration is a special case of affine registration, while there are more degrees of freedom associated with an affine registration. B-Spline deformable registration is a special type of deformable registration, in that it assumes the underlying deformation field can be expressed in terms of B-Splines. In general, this nonrigid registration may use a deformation field to describe how images are aligned, and the deformation field can be different for different regions of the images. This may allow for a lesser positional variation of features that may physically constrained from movement, such as portions of the breast that are close to the chest wall attachment area, in comparison with greater positional variation of features of the breast that are subject to fewer physical constraints, such as tissue away from the chest surface.

Image processing and analysis involves extracting features, describing shapes and recognizing patterns. Such tasks refer to geometrical concepts such as size, shape, and orientation. Mathematical morphology uses concepts from set theory, geometry and topology to analyze geometrical structures in an image. In the context of image processing, morphology is the name of a specific methodology designed for the analysis of the geometrical structure in an image. Mathematical morphology examines the geometrical structure of an image in order to make certain features apparent, distinguishing meaningful information from irrelevant distortions, by reducing it to a simplification, or skeletonization. Such a skeleton suffices for feature recognition and can be handled much more economically than the full symbol.

The basic morphological operations, erosion and dilation, produce contrasting results when applied to either grayscale or binary images. Erosion shrinks image objects while dilation expands them. Dilation generally increases the sizes of objects, filling in holes and broken areas, and connecting areas that are separated by spaces smaller than the size of the structuring element.

Finite Element Analysis (FEA) is a branch of applied mathematics for numerical modeling of physical systems. FEA is a numerical technique for finding approximate solutions to complex mathematical operations, such as partial differential equations and integral equations. FEA uses a system of points called nodes that make a grid called a mesh. This mesh is modeled to contain the material and structural properties that define how the structure will react to certain loading and boundary conditions. Nodes are assigned at a certain density throughout the material depending on the anticipated stress gradient levels of a particular area. Regions subject to large gradient of stress usually have a higher node density than those experiencing little or no gradient in stress. The mesh may be thought of like a spider web in that from each node, there extends a mesh element to each of the adjacent nodes.

Finite Element Modeling (FEM) allows detailed approximations of physical objects of where structures bend or twist, and may indicate the distribution of displacements. FEM may provide simulation options for controlling the complexity of both modeling and analysis of a system. Levels of accuracy required and associated computational time requirements may be managed simultaneously to streamline some types of computational applications.

There is an unmet need for registration of intraoperative surface images with preoperative volumetric images as an alternative to wire localization to reduce positive margins and minimize amount of tissue removed.

### SUMMARY OF THE INVENTION

Embodiments of the present invention provide a system and method for providing registration between breast shapes before and during surgery. In this regard, one embodiment of such a method, among others, can be broadly summarized by the following steps: identifying an air/tissue boundary from a volumetric image created at a first time; processing the volumetric image with an image filter to emphasize the air/tissue boundary; and registering a surface optically scanned image, with the filtered volumetric image, where the surface optically scanned image is created at a second time.

In architecture, the present system for registering an optically scanned surface image with a volumetric image, comprises a memory and a processor configured by the memory to perform the steps of: identifying an air/tissue boundary from a volumetric image created at a first time;
processing the volumetric image with an image filter to emphasize the air/tissue boundary; and
registering a surface optically scanned image, with the filtered volumetric image, where the surface optically scanned image is created at a second time.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1 is a diagram of a breast of each of three subjects in the prone position.

FIG. 2 is a diagram of the breast of each of the three subjects in the supine position.

FIG. 3 is a flow chart of a first embodiment of a method for registering intraoperative optical scan images with a preoperative volumetric image.

FIG. 4 is a flow chart expanding the description of creating a binary image of the volumetric image.

FIG. 5 is a flow chart of a second embodiment for registering intra-operative optical scan images with a preoperative volumetric image using FEM.

FIG. 6 is a block diagram of a computer system configured to implement the first embodiment of the method for registering intraoperative optical scan images with a preoperative volumetric image.

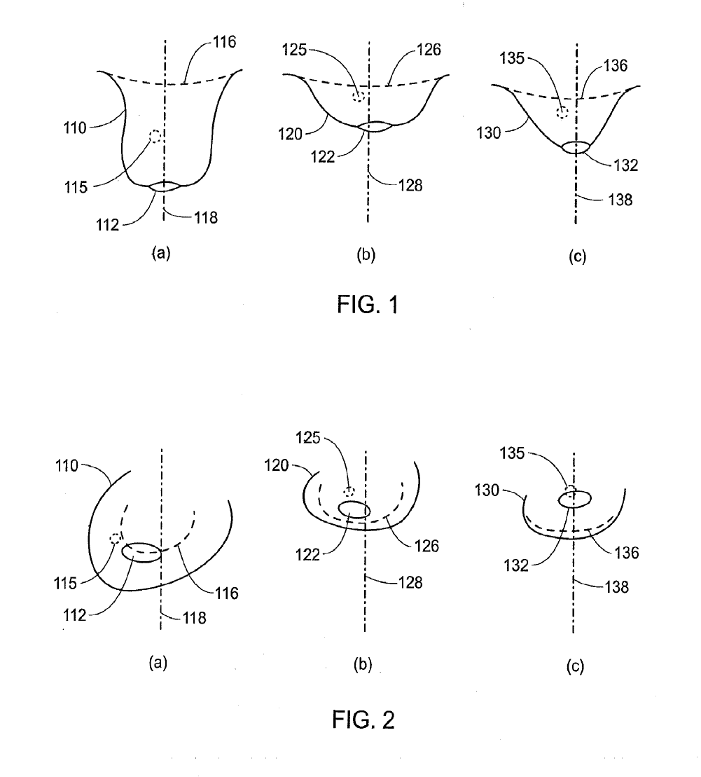

### DETAILED DESCRIPTION

Reference will now be made in detail to embodiments of the present invention, examples of which are illustrated in the accompanying drawings. Wherever possible, the same reference numbers are used in the drawings and the description to refer to the same or like parts.

The present invention presents a technique to register a volumetric data to a surface data, regardless how the volume/surface are obtained. Ensuring robust and accurate registration between volumetric images and surface images using image-based techniques may entail applying surface dilation upon the air/tissue interface of a volumetric image to facilitate registration with surface images.

The following provides an example of use of the present system and method in the framework of breast conservation surgery, although it should be noted that the present invention is not limited to use in breast conservation surgery. This example illustrates a spatial transformation between optical surface images and volumetric images. Specifically, the present description is with regard to establishing a spatial transformation between intraoperative optical surface images and preoperative volumetric images (including magnetic resonance (pMR) and CT, although pMR is much more widely used than CT to provide unparalled delineation of soft tissues in the breast) of a patient. It should be noted that pMR is used in the present description for exemplary purposes only and is not intended to be a limitation to the present invention. Rather than use the same fixed position for both the prone pre-operative volumetric image and the operation, the method presented uses a traditional supine operating room position, scans the breast surface with an optical scanner, and deforms the prone volumetric image to match the supine intra-operative surface image contours.

While the examplary embodiments refer to registration between a preoperative image and an intraoperative image, this disclosure should be understood to relate to registration of images between any two temporal points, including, but not limited to, a first preoperative image created at a first time, and a second preoperative image created at a second time.

Image Registration

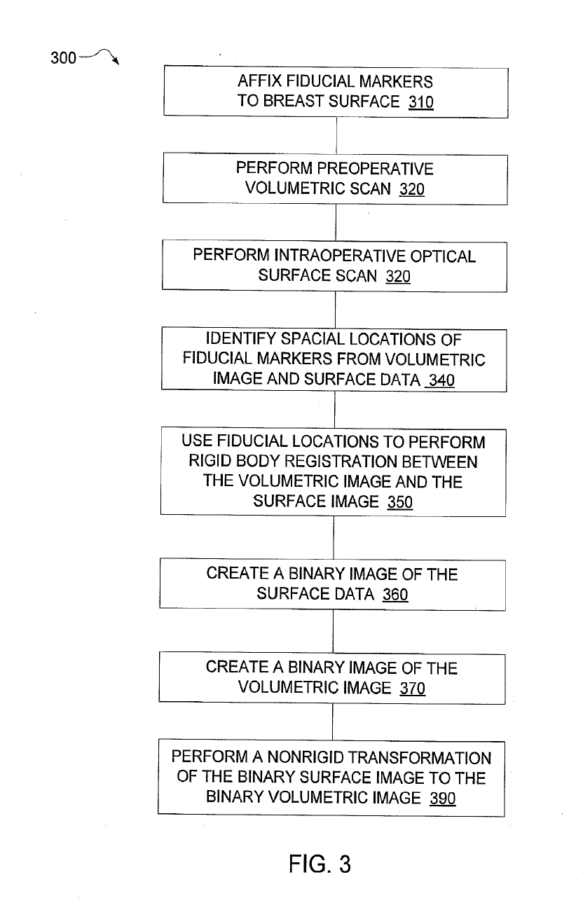

FIG. 3 is a flow chart 300 showing a first embodiment of a method for registering intraoperative optical scan images with a preoperative MR image. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

As shown by block 310, fiducial markers are affixed to the breast surface. As discussed above, the fiducial markers provide a common reference for images taken under different circumstances. For a first example, the fiducials may be used to provide a common reference between successive scans of a breast taken with the patient in two different positions, such as a first, preoperative image (block 320) obtained while the patient is in a prone position, and a second, interoperative image (block 330) taken when the patient is in a supine position. While the tissue of the breast may be deformed in the second image relative to the first image, the fiducials provide a constant reference in regard to the surface (skin) location between the first image and the second image. The fiducials serve as a known reference point to use as a basis for integrating data between the first image and the second image.

As shown by block 340, the spatial locations of the fiducial markers in the first image and the second image, are identified. Depending upon the position of the patient when each of the images were created, the fiducial markers may be in relatively similar positions, as between two successive supine images, or relatively disparate, as between a prone image and a supine image.

As shown by block 350, a rigid body registration is performed between the volumetric image and the surface image, based upon the fiducial locations by matching the fiducial markers identified in the coordinate system of the volumetric image with the fiducial markers identified in the coordinate system of the surface image. A rigid body registration may require a translation and rotation, but generally does not require scaling or shearing.

As shown by block 360, a binary image of the surface data in the intraoperative image is created. Creating a binary image of the surface date in the preoperative volumetric image is shown by block 370. Generally, both the intraoperative image and the preoperative images may be grayscale images, where each pixel (two dimensional) or voxel (three dimensional) is represented as a gray color in a range between darkest (black) or lightest (white). In contrast, a binary image represents each pixel or voxel as either black or white, without any shades of gray in between. Therefore, creating a binary image from a grayscale image is a technique for emphasizing certain desired features in an image, and removing other features from the image. Note that while grayscale images are discussed in this example, there is no objection to similarly creating binary images from color images.

As shown by block 360, the features emphasized are the surface features of the breast in the intraoperative surface image. For example, the binary image may be created from the surface data by setting the intensity values of the voxels that are sufficiently close to the breast surface to unity and zero otherwise. A typical range for voxels defined as being sufficiently close to the breast surface may be, but is not limited to, voxels within 10 mm of the breast/air interface.

As shown by block 370, the emphasized features are the portions of the image representing the voxels at the tissue/air interface of the volumetric image. Block 370 is discussed in greater detail below.

A purpose for creating binary images may be to emphasize features common to both the preoperative image and the intraoperative image in order to perform the nonrigid transformation of the binary surface image to the binary volumetric image of block 390. Both binary image volumes highlight the same breast/air interface at two distinctive temporal points, which allows the two binary image volumes to be nonrigidly registered using the rigid registration as a starting point. As an example, the nonrigid registration can be performed first by performing an affine registration, followed by a deformable registration, subject to a set of constrains that the corresponding fiducial points match. Further, the deformable registration may be, but is not limited to, a B-Spline deformable registration. Persons having ordinary skill in the art will recognize that other types of nonrigid registration and deformable registration may also be used within the scope of this disclosure.

Fiducials may also be used to provide a common reference for images taken using different imaging technologies while the patient is in the same position. In a second example, the first image may be a preoperative volumetric MR image (block 320) of the patient in a supine position, and the second image may be an inter-operative image (block 330) of the patient in a supine position. In this second example, while the shape of the breast may not differ as greatly as between the differences caused by gravity between the prone and supine images of the first example, there may be differences due to other factors, such as the hydration levels of the patient at two different time, or the effects of intraoperative surgical incisions compared with the preoperative images. As with the first example, the fiducials serve as a known reference point to use as a basis for integrating data between the first image and the second image.

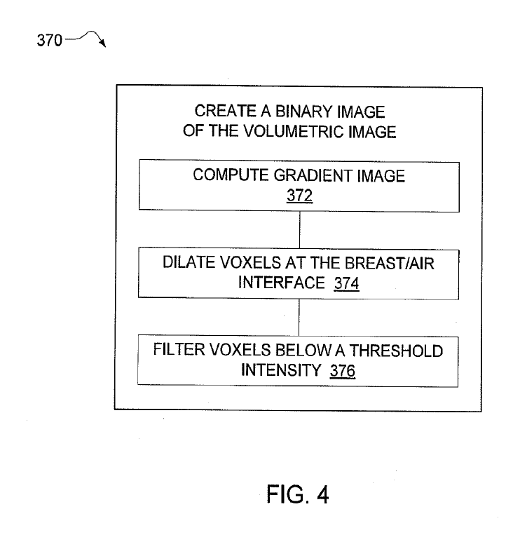

FIG. 4 shows a flow chart expanding the description of creating a binary image of the volumetric image of block 370. As shown by block 372, a gradient image of the volumetric image is computed. A gradient image is a directional change in the intensity or color in an image. Gradient images may be used to extract information from images. As shown by block 372, a gradient image of the volumetric image may be generated to identify anatomical boundaries, such as the breast/air interface.

As shown by block 374, a dilated image of the volumetric gradient image is computed. As with the optically scanned surface image, the target of the dilation are voxels at the breast/air interface. Therefore, a similar range of voxels will be targeted for dilation as were targeted for the optically scanned surfaces image, for example, voxels representing portions of the breast within 10 mm of the breast/air interface.

Thresholding

As shown by block 376, voxels below a threshold intensity are filtered. While in general, the threshold intensity level may be chosen to be any intensity, for example, to provide a more granular grayscale image, for a binary image the threshold may be set to maximum intensity, so that any pixels or voxels that were not set to maximum intensity during dilation are filtered.

Additional Processing

Additional pre-registration processing, such as rasterization, Gaussian smoothing, and morphology operations, is possible in order to further improve the robustness of image registration for example, the rigid body registration performed in block 350. For example, the resulting dilated volumetric gradient image as well as the surface optically scanned image may be Gaussian-smoothed (for example, with a kernel of 5×5×5) to reduce the noise level. Registration of the surface optically scanned image with the dilated volumetric gradient image may be performed. For example, the dilated volumetric gradient image may be used as the fixed image and the rasterized surface optically scanned image may be used as the floating image. Registration may be based on maximization of mutual information between the two image volumes.

It should be noted that additional processing or filtering of the preoperative image may be employed to optimize registration with specific types of intraoperative images within the scope of this disclosure. The goal of such parameter optimization is to emphasize features in the preoperative image to match similar features that are inherently emphasized in an intraoperative image of the same organ. These parameter manipulations may be based on a predetermined set of parameters depending upon the intraoperative image type, or, alternatively, may be optimized based on conditions particular to a specific intraoperative image.

Note that the method depicted in FIG. 3 is applicable to scenarios where registration is being performed between a volumetric image and a surface scanned image where there may be a significant amount of tissue deformation. For example, there may be a significant deformation between a volumetric image performed while the subject is in a prone position and a surface scanned image while the subject is in a supine position. In alternative scenarios, such as between a volumetric image performed while the subject is in a supine position and a surface scanned image while the subject is also in a supine position, there may be less deformation. Therefore the creation of binary images of blocks 360 and 370 and the non-rigid transformation of block 390 may not be required.

While the abovementioned patient registration method is provided in the framework of breast conservation surgery, the present system and method is capable of being implemented in other image-guidance systems as long as registration between intraoperative and preoperative images is feasible. Non-limited examples include, but are not limited to, image-guided surgery of the liver and of the abdomen. Of course, other examples exist for implementation of the present system and method in other image-guidance systems.

Finite Element Method Modeling

There may be scenarios where the surface of the optical scanner image and the surface of the MR image do not perfectly align following a rigid transformation. Under a second embodiment of a method for registering intra-operative optical scan images with preoperative volumetric images, Finite Element Modeling (FEM) may be used in situations where rigid transformations may yield errors. Such modeling may take into account the physical properties of the tissue in the images, rather than only attempting to linearly correlate the distance between image features and constants, such as fiducials. By modeling the physical properties of the tissue, FEM may more accurately register prone volumetric images with supine surface images.

In some situations, FEM may leverage additional information about the tissue in the volumetric and surface images to more accurately model the transformation. For example, breast tissue may exhibit different elastic properties in a first region of the breast than the elastic properties of a second region of the breast. For example, regions of the breast corresponding to gland tissue may be assigned a first elastic modulus, and regions of the breast where invasive ductal carcinoma is detected may be assigned a second elastic modulus, where the second elastic modulus is greater than the first elastic modulus. Examples of other tissues with known elastic modulus, include, but are not limited to, normal fat tissue, normal gland tissue, fibrous tissue, invasive ductal carcinoma, and ductal carcinoma in situ (DCIS). Whereas a rigid transformation may produce errors due to not taking the different elastic properties of different regions of tissue into account, a FEM process may produce more accurate results based on more accurately modeling the properties of different regions of tissue.

The finite element model may be further refined by using different mathematical models for the tissue in the images. While a simple linear elastic model may be used to model breast tissue, additional models may include, but are not limited to, linear elastic, neo-hookean, exponential, and other non-linear approaches.

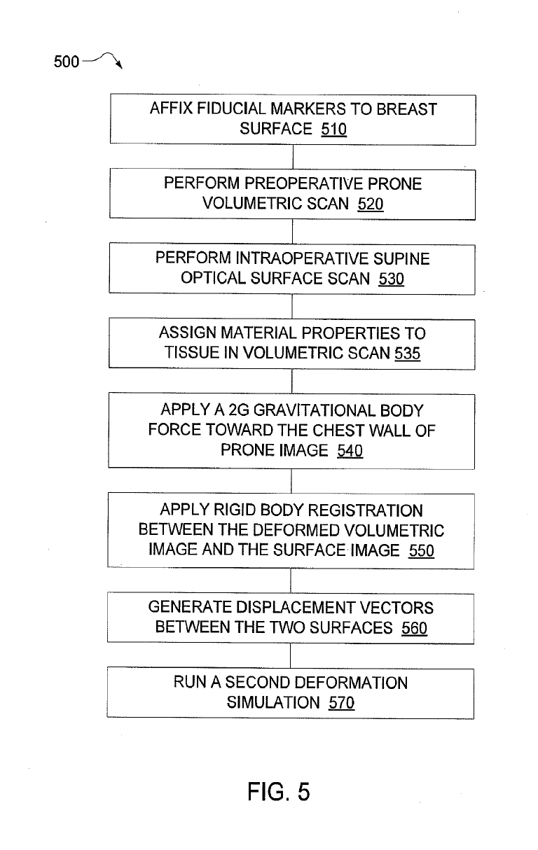

FIG. 5 is a flowchart 500 of a method for performing FEM between a prone volumetric image and a supine surface image. Fiducial markers are attached to the breast surface (block 510), and a preoperative volumetric scan is taken of the subject while the subject is in the prone position (block 520,). As shown by block 530, an intra-operative optical surface scan may be performed while the patient is in the supine position.

As shown by block 535, material properties are assigned according to the identified tissue in the volumetric scan. For example, chest wall tissue may be treated as being relatively inelastic, and may therefore only deform mimimally between when the subject is in the prone and the supine positions. In contrast, gland and fat tissue may have higher elasticity properties, while muscle or some types of cancerous tissue may have lower elasticity properties. By identifying types of tissue and assigning different material properties and properties to the different types of tissue based upon the identified tissue type, the FEM may more accurately model the deformation between the prone position and the supine position.

As shown by block 540, the volumetric prone image is deformed with FEM by applying a computational model to the image where a simulated gravitational force of 2 G is applied to the breast in the direction of the chest wall. This operation attempts to normalize the prone image with the supine image, as the supine image is performed while the breast is subject to one gravitational force in the direction toward the chest wall, and the prone image is taken when the breast is subject to one gravitational force in the direction away from the chest wall.

As shown by block 550, a rigid body transformation is performed between the deformed (normalized) volumetric image and the surface image. As shown by block 560, displacement vectors are generated, for example between the two surfaces. As shown by block 570 a second deformation simulation is performed. Alternatively, displacement vectors may be generated by matching the set of fiducial locations and deforming the breast shape in an inverse modeling approach to avoid overfitting the shape that can be adversely affected by measurement error.

It should be noted that in accordance with an alternative embodiment of the invention, FEM may also be used for registering supine MRI, not just prone MRI. In accordance with this alternative embodiment, the flowchart of FIG. 5 would be slightly modified, with block 520 changing to read, “perform preoperative supine volumetric scan, and block 540 being changed to read, “apply a 2 G gravitational force adjustment toward the chest wall of supine image. The rest of FIG. 5 would remain the same, as well as the steps performed.

Mapping Meshes

The breast surface may be modeled by mapping the curved surface area as a mesh of elements. The elements may be represented by polygons, for example, triangles. Deformation calculations may be simplified by calculating displacement vectors for specific points, or nodes, on the mapping mesh, rather than calculating displacement vectors for every point on the surface. The nodes may be, for example, the corners of each triangle in the mapping mesh. Once the location of the nodes is calculated after deformation, the intermediate points may be approximated, for example, by linear interpolation.

Similarly, mapping meshes may be used to correlate surface locations on the volumetric scan to locations on the surface scan. One exemplary approach is to map points on the surface of the volumetric image to the closest node locations (after rigid transform) on the optical scanner surface. The optical scan mesh may typically have much higher density, so interpolation between nodes is not needed. An alternative approach may be to find the closest point on each element of the optical scan, as opposed to the closest node.

System

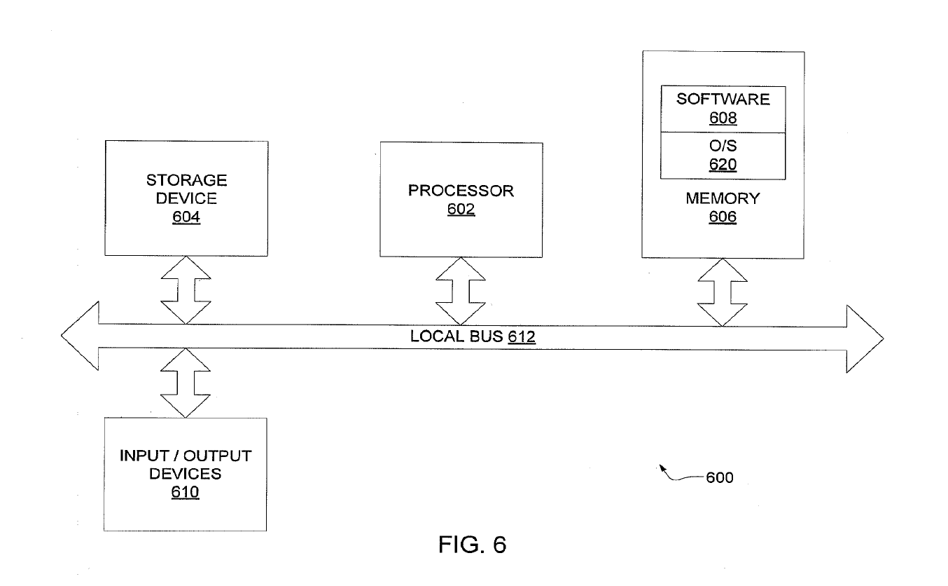

The present system for executing the functionality described in detail above may be a computer, an example of which is illustrated by FIG. 6. The system 600 contains a processor 602, a storage device 604, a memory 606 having software 608 stored therein that defines the abovementioned functionality, input and output (I/O) devices 610 (or peripherals), and a local bus, or local interface 612 allowing for communication within the system 600. The local interface 612 can be, for example but not limited to, one or more buses or other wired or wireless connections, as is known in the art. The local interface 612 may have additional elements, which are omitted for simplicity, such as controllers, buffers (caches), drivers, repeaters, and receivers, to enable communications. Further, the local interface 612 may include address, control, and/or data connections to enable appropriate communications among the aforementioned components.

The processor 602 is a hardware device for executing software, particularly that stored in the memory 606. The processor 602 can be any custom made or commercially available single core or multi-core processor, a central processing unit (CPU), an auxiliary processor among several processors associated with the present system 600, a semiconductor based microprocessor (in the form of a microchip or chip set), a macroprocessor, or generally any device for executing software instructions.

The memory 606 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 606 may incorporate electronic, magnetic, optical, and/or other types of storage media. Note that the memory 606 can have a distributed architecture, where various components are situated remotely from one another, but can be accessed by the processor 602.

The software 608 defines functionality performed by the system 600, in accordance with the present invention. The software 608 in the memory 606 may include one or more separate programs, each of which contains an ordered listing of executable instructions for implementing logical functions of the system 600, as described below. The memory 606 may contain an operating system (0/S) 620. The operating system essentially controls the execution of programs within the system 600 and provides scheduling, input-output control, file and data management, memory management, and communication control and related services.

The I/O devices 610 may include input devices, for example but not limited to, a medical imaging system, such as an MR, CT or optical scanning system, a keyboard, mouse, scanner, microphone, etc. Furthermore, the I/O devices 610 may also include output devices, for example but not limited to, a printer, display, etc. Finally, the I/O devices 610 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 600 is in operation, the processor 602 is configured to execute the software 608 stored within the memory 606, to communicate data to and from the memory 606, and to generally control operations of the system 600 pursuant to the software 608, as explained above. The system 600 may be utilized at several times during surgery to register and re-register intraoperative optically scanned surface image with a preoperative volumetric image. Additional re-registrations may be ordered, for instance, by a surgeon as organ deformation progresses during surgery. Ideally, the registration procedure occurs in the background after the intraoperative image is obtained, without disrupting or delaying the normal course of surgery.

In summary, a method and system is provided for improving the registration of a preoperative MR image with an intraoperative surface optical image by mapping the air to tissue interface of each image and using fiducials to constrain a subsequent non-rigid registration. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for registering an optically scanned surface image with a volumetric image, comprising the steps of:
identifying an air/tissue boundary from a volumetric image created at a first time;
processing the volumetric image with an image filter to emphasize the air/tissue boundary; and
registering a surface optically scanned image, with the filtered volumetric image, where the surface optically scanned image is created at a second time.

2. The method of claim 1, wherein processing the volumetric image comprises finite element modeling.

3. A method for registering an optically scanned surface image with a volumetric image, comprising the steps of:
obtaining a volumetric image created at a first time;
obtaining a surface optically scanned image created at a second time;
identifying spatial locations of fiducial markers from the volumetric image and the surface image; and
using fiducial locations to perform rigid body registration between the volumetric image and the surface image.

4. The method of claim 3, further comprising the steps of:
creating a binary image of data of the surface image;
creating a binary image of data of the volumetric image; and
performing a nonrigid transformation of the binary surface image to the binary volumetric image.

5. The method of claim 4, wherein the step of creating a binary image of the volumetric image further comprises the steps of:
computing a gradiant image;
dilating voxels at a breast/air interface; and
filtering voxels below a threshold intensity.

6. A system for registering an optically scanned surface image with a volumetric image, comprising:
a memory; and
a processor configured by the memory to perform the steps of:
identifying an air/tissue boundary from a volumetric image created at a first time;
processing the volumetric image with an image filter to emphasize the air/tissue boundary; and
registering a surface optically scanned image, with the filtered volumetric image, where the surface optically scanned image is created at a second time.

7. The system of claim 6, wherein processing the volumetric image with an image filter comprises finite element modeling.

8. A method for registering volumetric data to a surface data, comprising the steps of:
obtaining a volumetric image of a subject in a first position;
obtaining a surface image of a subject in a second position; and
mapping the surface image to the volumetric image.
